(19) United States
(12) Patent Application Publication
(10) Pub. No.: US 2024/0028322 A1
(43) Pub. Date: Jan. 25, 2024

(54) COORDINATED UPGRADE WORKFLOW FOR REMOTE SITES OF A DISTRIBUTED CONTAINER ORCHESTRATION SYSTEM

(71) Applicant: VMware, Inc., Palo Alto, CA (US)

(72) Inventors: Weiqing WU, Cupertino, CA (US); Uday Suresh MASUREKAR, Sunnyvale, CA (US); Liang CUI, Beijing (CN); Govind HARIDAS, San Jose, CA (US); Narendra Kumar BASUR SHANKARAPPA, Fremont, CA (US)

(21) Appl. No.: 17/939,713

(22) Filed: Sep. 7, 2022

(30) Foreign Application Priority Data
Jul. 21, 2022 (WO) PCT/CN2022/107036

(51) Int. Cl. G06F 8/65; G06F 9/455

(52) U.S. Cl. CPC G06F 8/65; G06F 9/45558; G06F 2009/4557

(57) ABSTRACT

An example method of upgrading remote sites of a distributed container orchestration system includes: deploying, by upgrade software executing in a data center remote from the remote sites, a second container orchestration (CO) control plane executing concurrently with a first CO control plane, the second CO control plane having a second version different than a first version of the first CO control plane, the first CO control plane initially managing all of the remote sites; upgrading, by the upgrade software, CO support software of a first portion of the remote sites; adding, by the upgrade software, the first portion of the remote sites to a second CO cluster managed by the second CO control plane; and removing, by the upgrade software, the first portion of the remote sites from a first CO cluster managed by the first CO control plane.

### CROSS-REFERENCE

This application is based upon and claims the benefit of priority from International Patent Application No. PCT/CN2022/107036, filed on Jul. 21, 2022, the entire contents of which are incorporated herein by reference.

Applications today are deployed onto a combination of virtual machines (VMs), containers, application services, and more. For deploying such applications, a container orchestrator (CO) known as Kubernetes® has gained in popularity among application developers. Kubernetes provides a platform for automating deployment, scaling, and operations of application containers across clusters of hosts. It offers flexibility in application development and offers several useful tools for scaling.

In a Kubernetes system, containers are grouped into logical unit called “pods” that execute on nodes in a cluster (also referred to as “node cluster”). Containers in the same pod share the same resources and network and maintain a degree of isolation from containers in other pods. The pods are distributed across nodes of the cluster. In a typical deployment, a node includes an operating system (OS), such as Linux®, and a container engine executing on top of the OS that supports the containers of the pod. A node can be a physical server or a VM.

In a radio access network (RAN) deployment, such as a 5G RAN deployment, cell site network functions can be realized as Kubernetes pods. Each cell site can be deployed with a single server. In one type of deployment, each cell site operates as a separate Kubernetes cluster. That is, the server in each cell site includes the Kubernetes control plane managing its pods on that server. This deployment is not optimal for many providers since resources on the single server are at a premium. In another type of deployment, the Kubernetes control plane executes centrally and manages pods distributed across the cell sites. In this type of deployment, the distributed nature creates challenges when upgrading the software at the cell sites.

Embodiments include a method of upgrading remote sites of a distributed container orchestration system includes: deploying, by upgrade software executing in a data center remote from the remote sites, a second container orchestration (CO) control plane executing concurrently with a first CO control plane, the second CO control plane having a second version different than a first version of the first CO control plane, the first CO control plane initially managing all of the remote sites; upgrading, by the upgrade software, CO support software of a first portion of the remote sites; adding, by the upgrade software, the first portion of the remote sites to a second CO cluster managed by the second CO control plane; and removing, by the upgrade software, the first portion of the remote sites from a first CO cluster managed by the first CO control plane.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1 is a block diagram of a virtualized computing system in which embodiments described herein may be implemented.

FIG. 2 is a block diagram depicting a server of a site in a distributed container orchestration system according to embodiments.

FIG. 3 is a block diagram depicting state of virtualized computing system during an upgrade according to embodiments.

FIG. 4 is a flow diagram depicting a method of upgrading remote sites of a distributed container orchestration system.

### DETAILED DESCRIPTION

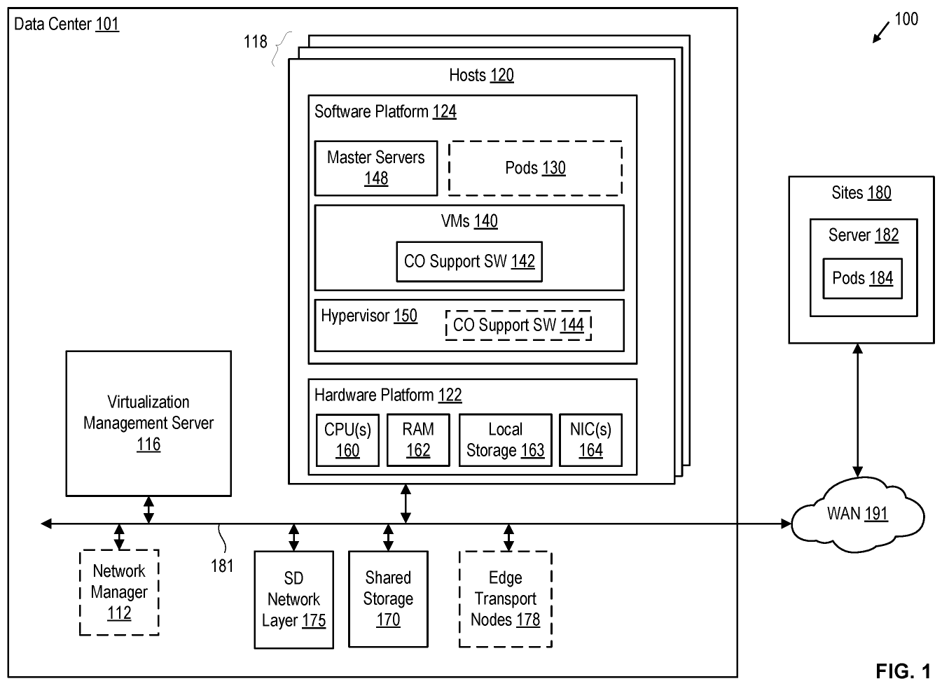

FIG. 1 is a block diagram of a virtualized computing system 100 in which embodiments described herein may be implemented. Virtualized computing system includes a data center 101 in communication with a plurality of sites 180 through a wide area network (WAN) 191 (e.g., the public Internet). Sites 180 can be geographical dispersed with respect to each other and with respect to data center 101 For example, sites 180 can be part of a radio access network (RAN) dispersed across a geographic region and serving different portions of such geographic region. In embodiments, data center 101 comprises a software-defined data center (SDDC) deployed in a cloud, such as a public cloud, private cloud, or multi-cloud system (e.g., a hybrid cloud system). In other embodiments, data center 101 can be deployed by itself outside of any cloud environment.

Data center 101 includes hosts 120. Hosts 120 may be constructed on hardware platforms such as an x86 architecture platforms. One or more groups of hosts 120 can be managed as clusters 118. As shown, a hardware platform 122 of each host 120 includes conventional components of a computing device, such as one or more central processing units (CPUs) 160, system memory (e.g., random access memory (RAM) 162), one or more network interface controllers (NICs) 164, and optionally local storage 163. CPUs 160 are configured to execute instructions, for example, executable instructions that perform one or more operations described herein, which may be stored in RAM 162. NICs 164 enable host 120 to communicate with other devices through a physical network 181. Physical network 181 enables communication between hosts 120 and between other components and hosts 120 (other components discussed further herein).

In the embodiment illustrated in FIG. 1, hosts 120 access shared storage 170 by using NICs 164 to connect to network 181. In another embodiment, each host 120 contains a host bus adapter (HBA) through which input/output operations (IOs) are sent to shared storage 170 over a separate network (e.g., a fibre channel (FC) network). Shared storage 170 include one or more storage arrays, such as a storage area network (SAN), network attached storage (NAS), or the like. Shared storage 170 may comprise magnetic disks, solid-state disks, flash memory, and the like as well as combinations thereof. In some embodiments, hosts 120 include local storage 163 (e.g., hard disk drives, solid-state drives, etc.). Local storage 163 in each host 120 can be aggregated and provisioned as part of a virtual SAN, which is another form of shared storage 170.

A software platform 124 of each host 120 provides a virtualization layer, referred to herein as a hypervisor 150, which directly executes on hardware platform 122. In an embodiment, there is no intervening software, such as a host operating system (OS), between hypervisor 150 and hardware platform 122. Thus, hypervisor 150 is a Type-1 hypervisor (also known as a “bare-metal” hypervisor). As a result, the virtualization layer in host cluster 118 (collectively hypervisors 150) is a bare-metal virtualization layer executing directly on host hardware platforms. Hypervisor 150 abstracts processor, memory, storage, and network resources of hardware platform 122 to provide a virtual machine execution space within which multiple virtual machines (VM) 140 may be concurrently instantiated and executed. One example of hypervisor 150 that may be configured and used in embodiments described herein is a VMware ESXi™ hypervisor provided as part of the VMware vSphere® solution made commercially available by VMware, Inc. of Palo Alto, CA.

Virtualized computing system 100 is configured with a software-defined (SD) network layer 175. SD network layer 175 includes logical network services executing on virtualized infrastructure of hosts 120 The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure. In embodiments, virtualized computing system 100 includes edge transport nodes 178 that provide an interface of host cluster 118 to WAN 191. Edge transport nodes 178 can include a gateway (e.g., implemented by a router) between the internal logical networking of host cluster 118 and the external network. Edge transport nodes 178 can be physical servers or VMs. Virtualized computing system 100 also includes physical network devices (e.g., physical routers/switches) as part of physical network 181, which are not explicitly shown.

Virtualization management server 116 is a physical or virtual server that manages hosts 120 and the hypervisors therein. Virtualization management server 116 installs agent(s) in hypervisor 150 to add a host 120 as a managed entity. Virtualization management server 116 can logically group hosts 120 into host cluster 118 to provide cluster-level functions to hosts 120, such as distributed power management, dynamic VM placement according to affinity and anti-affinity rules, and high-availability. The number of hosts 120 in host cluster 118 may be one or many. Virtualization management server 116 can manage more than one host cluster 118. While only one virtualization management server 116 is shown, virtualized computing system 100 can include multiple virtualization management servers each managing one or more host clusters.

In an embodiment, virtualized computing system 100 further includes a network manager 112. Network manager 112 is a physical or virtual server that orchestrates SD network layer 175. In an embodiment, network manager 112 comprises one or more virtual servers deployed as VMs. Network manager 112 installs additional agents in hypervisor 150 to add a host 120 as a managed entity, referred to as a transport node. One example of an SD networking platform that can be configured and used in embodiments described herein as network manager 112 and SD network layer 175 is a VMware NSX® platform made commercially available by VMware, Inc. of Palo Alto, CA. In other embodiments, SD network layer 175 is orchestrated and managed by virtualization management server 116 without the presence of network manager 112.

In embodiments, sites 180 perform software functions using containers. For example, in a RAN, sites 180 can include container network functions (CNFs) deployed as pods 184 by a container orchestrator (CO), such as Kubernetes. The CO control plane includes a master server 148 executing in host(s) 120. A master server 148 can execute in VM(s) 140 and includes various components, such as an application programming interface (API), database, controllers, and the like. A master server 148 is configured to deploy and manage pods 184 executing in sites 180. In some embodiments, a master server 148 can also deploy pods 130 on hosts 120 (e.g., in VMs 140).

In embodiments, VMs 140 include CO support software 142 to support execution of pods 130. CO support software 142 can include, for example, a container runtime, a CO agent (e.g., kubelet), and the like. In some embodiments, hypervisor 150 can include CO support software 144. In embodiments, hypervisor 150 is integrated with a container orchestration control plane, such as a Kubernetes control plane. This integration provides a “supervisor cluster” (i.e., management cluster) that uses VMs to implement both control plane nodes and compute objects managed by the Kubernetes control plane. For example, Kubernetes pods are implemented as “pod VMs,” each of which includes a kernel and container engine that supports execution of containers. The Kubernetes control plane of the supervisor cluster is extended to support VM objects in addition to pods, where the VM objects are implemented using native VMs (as opposed to pod VMs). In such case, CO support software 144 can include a CO agent that cooperates with a master server 148 to deploy pods 130 in pod VMs of VMs 140.

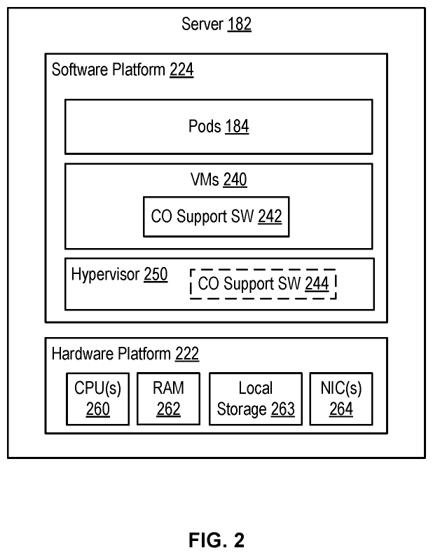

FIG. 2 is a block diagram depicting a server 182 of a site 180 according to embodiments. Server 182 includes may be constructed on a hardware platform such as an x86 architecture platform. As shown, a hardware platform 222 of server 182 includes conventional components of a computing device, such as one or more CPUs 260, system memory (e.g., RAM 262), one or more NICs 264, and local storage 263. CPUs 260 are configured to execute instructions, for example, executable instructions that perform one or more operations described herein, which may be stored in RAM 262. NICs 264 enable server 182 to communicate with other devices (i.e., data center 101).

A software platform 224 of server 182 a hypervisor 250, which directly executes on hardware platform 222. In an embodiment, there is no intervening software, such as a host OS, between hypervisor 250 and hardware platform 222. Thus, hypervisor 250 is a Type-1 hypervisor (also known as a “bare-metal” hypervisor). Hypervisor 150 supports multiple VMs 240, which may be concurrently instantiated and executed Pods 184 execute in VMs 240. In embodiments, VMs 240 include CO support software 242 to support execution of pods 184. CO support software 242 can include, for example, a container runtime, a CO agent (e.g., kublet), and the like. In some embodiments, hypervisor 250 can include CO support software 244 that functions as described above with hypervisor 150. Notably, in embodiments, software platform 124 omits a master server, since the CO control plane is located in data center 101. This conserves resources of server 182 for use with pods 184.

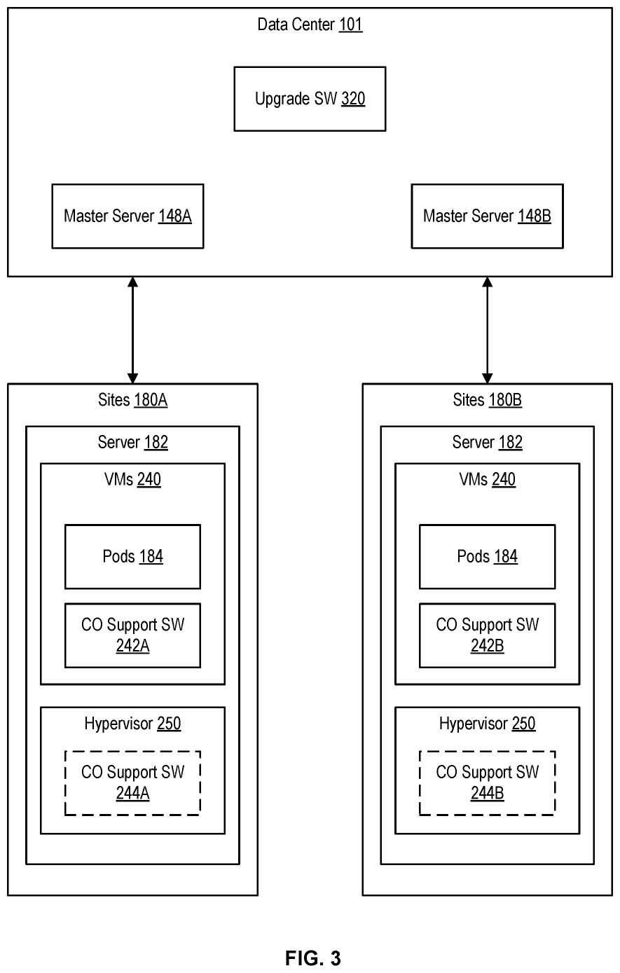

FIG. 3 is a block diagram depicting state of virtualized computing system 100 during an upgrade according to embodiments. In the embodiments above, the CO control plane executes centrally in data center 101 and pods 184 are distributed across sites 180A remote from data center 101. This creates challenges for upgrading software at sites 180A. Users desire per-site granularity for upgrade instead of full CO cluster. The upgrade process can be long in cases of many sites. For example, a RAN deployment can have 10,000 or more sites. Further, users desire to keep some sites running with an older version of the software during the upgrade process to mitigate service interruption. This creates a situation where the CO cluster can have sites running different versions of the software, some upgraded with the newer version and others still running the older version. This can cause the CO cluster to transition to an inconsistent state.

In embodiments, data center 101 executes upgrade software 320. Upgrade software 320 can stand alone or can be part of a larger platform depending on the application. For example, upgrade software 320 can be part of a telecommunications platform deployed in data center 101 to manage a RAN deployment using sites 180. A user interacts with upgrade software 320 to perform an upgrade of the CO cluster. Rather than upgrade the master server of the CO cluster in place, upgrade software 320 deploys a second master server having the newer version. This results in creation of two CO clusters, one at the older version and another at the newer version. Thus, data center 101 executes a master server 148A at the older version and a master server 148B at the newer version. Initially, all sites 180 execute software at the older version and are managed by master server 148A.

During the upgrade process, upgrade software 320 upgrades the software at some sites 180 over time while other sites continue to execute software at the older version. This results in a division of sites 180 into sites 180A executing at the older version and sites 180B executing at the newer version. Sites 180A continue to be managed by master server 148A, while sites 180B after being upgraded are managed by master server 148B. For example, in sites 180A, VMs 240 include CO support software 242A at the older version. In cases hypervisor 250 includes CO support software, CO support software 244A executes at the older version. In sites 180B, VMs 240 include CO support software 242B at the newer version. In cases hypervisor 250 includes CO support software, CO support software 244B executes at the newer version. Each CO cluster (new version and older version) remain in a consistent state during the upgrade process. Once all sites 180 are upgraded to the new version, master server 148A can be shut down and removed and a single CO cluster exists at the newer version.

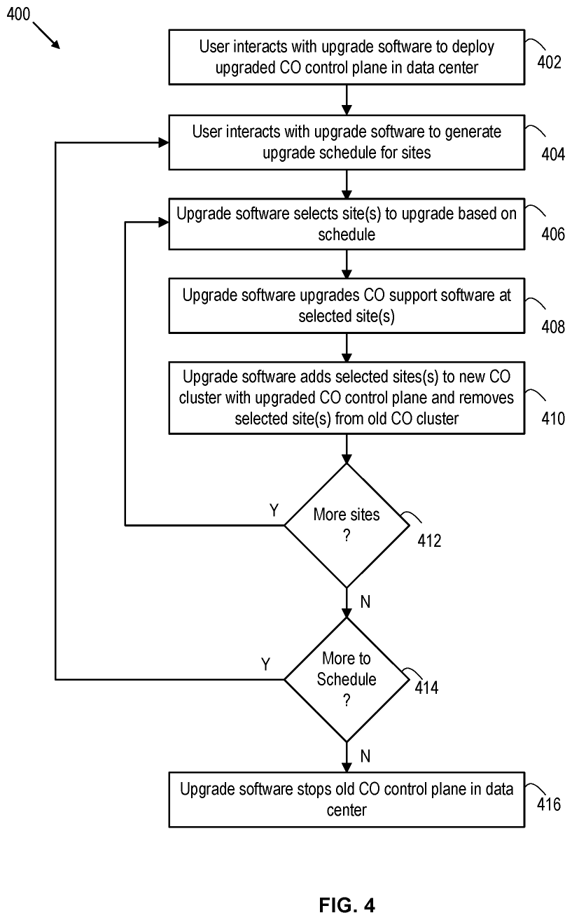

FIG. 4 is a flow diagram depicting a method 400 of upgrading remote sites of a distributed CO system. Method 400 begins at step 402, where a user interacts with upgrade software 320 to deploy an upgraded CO control plane in data center 101. In embodiments, the upgraded CO control plane includes master server 148B executing at a newer version compared to master server 148A executing at an older version. Thus, the upgraded CO control plane executes along side and concurrently with an older CO control plane. At this point in method 400, all sites are managed by the older CO control plane.

At step 404, the user interacts with upgrade software 320 to generate an upgrade schedule for a plurality of sites 180. For example, the user can select a subset of sites 180 to be upgraded. All of the selected sites can be upgraded concurrently, one-by-one serially, or in batches serially. The user can select sites to be upgraded such that other sites not being upgraded continue to provide service to mitigate interruption. At step 406, upgrade software 320 selects site(s) to upgrade based on the schedule. At step 408, upgrade software 320 upgrades the CO support software at the selected sites. At step 410, upgrade software 320 adds the selected sites to the new CO cluster with the upgraded CO control plane and removes the selected sites from the existing, older CO cluster. As described above, the upgraded sites 180B are managed by master server 148B running at the newer version and are removed from the CO cluster managed by master server 148A.

At step 412, upgrade software 320 determines if there are more sites to be upgraded based on the user's defined schedule. If so, method 400 returns to step 406. Otherwise, method 400 proceeds to step 414. At step 414, upgrade software 320 determines if there are more sites to be scheduled for upgrade. If so, method 400 returns to step 404, where the user can generate another schedule to upgrade another subset of the sites. Thus, sites can be upgraded in batches as defined by the user. Alternatively, all sites 180 can be selected for upgrade in one schedule. If there are no more sites to be scheduled for upgrade at step 414, method 400 proceeds to step 416. At step 416, upgrade software 320 stops the CO control plane executing at the older version. For example, upgrade software 320 shuts down and removes master server 148A.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of upgrading remote sites of a distributed container orchestration system, comprising:
deploying, by upgrade software executing in a data center remote from the remote sites, a second container orchestration (CO) control plane executing concurrently with a first CO control plane, the second CO control plane having a second version different than a first version of the first CO control plane, the first CO control plane initially managing all of the remote sites;
upgrading, by the upgrade software, CO support software of a first portion of the remote sites;
adding, by the upgrade software, the first portion of the remote sites to a second CO cluster managed by the second CO control plane; and
removing, by the upgrade software, the first portion of the remote sites from a first CO cluster managed by the first CO control plane.

2. The method of claim 1, further comprising:
upgrading, by the upgrade software, CO support software of a second portion of the remote sites;
adding, by the upgrade software, the second portion of the remote sites to the second CO cluster managed by the second CO control plane; and
removing, by the upgrade software, the second portion of the remote sites from the first CO cluster managed by the first CO control plane.

3. The method of claim 2, further comprising:
determining, by the upgrade software, that all of the remote sites are part of the second CO cluster managed by the second CO control plane; and
shutting down, by the upgrade software, the first CO control plane in the data center.

4. The method of claim 1, wherein the upgrade software upgrades the first portion of the remote sites according to a schedule.

5. The method of claim 1, wherein the CO support software executes in virtual machines (VMs), the VMs being managed by hypervisors executing in respective servers at the first portion of the remote sites.

6. The method of claim 5, wherein the CO support software further executes in the hypervisors.

7. The method of claim 1, wherein the first CO control plane comprises a master server executing at the first version and the second CO control plane comprises a master server executing at the second version.

8. A non-transitory computer readable medium comprising instructions to be executed in a computing device to cause the computing device to carry out a method of upgrading remote sites of a distributed container orchestration system, comprising:
deploying, by upgrade software executing in a data center remote from the remote sites, a second container orchestration (CO) control plane executing concurrently with a first CO control plane, the second CO control plane having a second version different than a first version of the first CO control plane, the first CO control plane initially managing all of the remote sites;
upgrading, by the upgrade software, CO support software of a first portion of the remote sites;
adding, by the upgrade software, the first portion of the remote sites to a second CO cluster managed by the second CO control plane; and
removing, by the upgrade software, the first portion of the remote sites from a first CO cluster managed by the first CO control plane.

9. The non-transitory computer readable medium of claim 8, further comprising:
upgrading, by the upgrade software, CO support software of a second portion of the remote sites;
adding, by the upgrade software, the second portion of the remote sites to the second CO cluster managed by the second CO control plane; and
removing, by the upgrade software, the second portion of the remote sites from the first CO cluster managed by the first CO control plane.

10. The non-transitory computer readable medium of claim 9, further comprising:
determining, by the upgrade software, that all of the remote sites are part of the second CO cluster managed by the second CO control plane; and
shutting down, by the upgrade software, the first CO control plane in the data center.

11. The non-transitory computer readable medium of claim 8, wherein the upgrade software upgrades the first portion of the remote sites according to a schedule.

12. The non-transitory computer readable medium of claim 8, wherein the CO support software executes in virtual machines (VMs), the VMs being managed by hypervisors executing in respective servers at the first portion of the remote sites.

13. The non-transitory computer readable medium of claim 12, wherein the CO support software further executes in the hypervisors.

14. The non-transitory computer readable medium of claim 8, wherein the first CO control plane comprises a master server executing at the first version and the second CO control plane comprises a master server executing at the second version.

15. A virtualized computing system, comprising:
a data center in communication with remote sites over a network forming a distributed container orchestration system; and
upgrade software, executing in the data center, configured to:
deploy a second container orchestration (CO) control plane executing concurrently with a first CO control plane, the second CO control plane having a second version different than a first version of the first CO control plane, the first CO control plane initially managing all of the remote sites;
upgrade CO support software of a first portion of the remote sites;
add the first portion of the remote sites to a second CO cluster managed by the second CO control plane; and
remove the first portion of the remote sites from a first CO cluster managed by the first CO control plane.

16. The virtualized computing system of claim 15, wherein the upgrade software is configured to:
upgrade CO support software of a second portion of the remote sites;
add the second portion of the remote sites to the second CO cluster managed by the second CO control plane; and
remove the second portion of the remote sites from the first CO cluster managed by the first CO control plane.

17. The virtualized computing system of claim 16, wherein the upgrade software is configured to:
determine that all of the remote sites are part of the second CO cluster managed by the second CO control plane; and
shutting down the first CO control plane in the data center.

18. The virtualized computing system of claim 15, wherein the upgrade software upgrades the first portion of the remote sites according to a schedule.

19. The virtualized computing system of claim 15, wherein the CO support software executes in virtual machines (VMs), the VMs being managed by hypervisors executing in respective servers at the first portion of the remote sites.

20. The virtualized computing system of claim 19, wherein the CO support software further executes in the hypervisors.
